(19) United States
(12) Patent Application Publication
(10) Pub. No.: US 2026/0307739 A1
(43) Pub. Date: Oct. 8, 2026

(54) VEHICLE BODY FRAMEWORK STRUCTURE

(71) Applicant: SUBARU CORPORATION, Tokyo (JP)

(72) Inventor: Akihiro MAEDA, Tokyo (JP)

(21) Appl. No.: 19/566,442

(22) Filed: Mar. 13, 2026

(30) Foreign Application Priority Data
Apr. 2, 2025 (JP) 2025-061417

(51) Int. Cl. B62D 27/02; B62D 21/02

(52) U.S. Cl. CPC B62D 27/023; B62D 21/02

(57) ABSTRACT

A vehicle body framework structure includes a first frame, a second frame, a biasing member, and a panel. The first frame is provided on a vehicle body and extends in a longitudinal direction of the vehicle body. The second frame is coupled to the first frame and suppresses displacement of the first frame in a vehicle width direction. The biasing member is fixed to the first frame and is disposed at a position close to a joint line portion at which the first frame and the second frame are coupled to each other. The panel is coupled to the first frame and the second frame by spot welding at a position adjacent to the joint line portion. The panel is provided with a ridge portion. A bead portion extending orthogonal to the ridge portion is provided on the ridge portion.

### CROSS-REFERENCE TO RELATED APPLICATIONS

The present application claims priority from Japanese Patent Application No. 2025-061417 filed on Apr. 2, 2025, the entire contents of which are hereby incorporated by reference.

### BACKGROUND

The disclosure relates to a vehicle body framework structure.

As illustrated in FIG. 7, a tire 101 provided in a vehicle is supported by a side frame 103 of a vehicle body via a suspension device 102, which is a biasing member. The side frame 103 is disposed on each of the left and right sides of the vehicle body and extends in the longitudinal direction of the vehicle body. The left and right side frames 103 are coupled to each other by a cross member 104, which is a vehicle body framework. The cross member 104 is a member that reinforces the left and right side frames 103.

The suspension device 102 includes a lateral link 102a, a damper unit 102b, and the like. The damper unit 102b is formed by unitizing a damper, a suspension spring, and the like.

A load (vibration) from the tire 101 during traveling is transmitted to the side frame 103 via the suspension device 102. The side frame 103 is a member that directly receives the load from the suspension device 102. The side frame 103 is a rigid body and extends in the longitudinal direction of the vehicle body.

Therefore, when the side frame 103 receives a push-up load from the suspension device 102, as illustrated in FIG. 7, the lower end of the side frame 103 tends to be displaced outward in the vehicle width direction. The displacement of the side frame 103 is suppressed by the cross member 104. As a result, due to the load that displaces the side frame 103, stress is likely to be concentrated on the relatively fragile coupling portion (welded portion) between the cross member 104 and the side frame 103.

A floor panel 105 is joined to upper surfaces of the side frame 103 and the cross member 104. The floor panel 105 is a thin steel plate. The floor panel 105 is integrally formed by overlapping weld margins of a plurality of panels 105a and 105b and joining the weld margins by spot-welding.

When the weld point in the spot welding of the floor panel 105 is in the vicinity of the joint line portion 106 between the side frame 103 and the cross member 104, or in the vicinity of a ridge portion formed when the floor panel 105 is bent, and is close to the suspension device 102, stress is likely to be concentrated on the weld point. When the stress is concentrated on the weld point, the spot weld at the weld point is easily peeled off.

For example, Japanese Patent No. 6962975 discloses a technique in which a center pillar stiffener, which is a second framework, and a side sill, which is a first framework, are coupled by spot welding at predetermined intervals in the vehicle-body longitudinal direction, and beads extending in the vertical direction are formed between adjacent spot welds to suppress peeling of the spot welds.

### SUMMARY

An aspect of the disclosure provides a vehicle body framework structure. The vehicle body framework structure includes a first frame, a second frame, a biasing member, and a panel. The first frame is provided on a vehicle body and extends in a longitudinal direction of the vehicle body. The second frame is coupled to the first frame and is configured to suppress displacement of the first frame in a vehicle width direction. The biasing member is fixed to the first frame and is disposed at a position close to a joint line portion at which the first frame and the second frame are coupled to each other. The panel is coupled to the first frame and the second frame. The panel is coupled to the first frame and the second frame by spot welding at a position adjacent to the joint line portion. The panel is provided with a ridge portion extending toward the position where spot welding is performed. A bead portion extending orthogonal to the ridge portion is provided on the ridge portion, at a portion adjacent to the position where the spot welding is performed.

### BRIEF DESCRIPTION OF THE DRAWINGS

The accompanying drawings are included to provide a further understanding of the disclosure and are incorporated in and constitute a part of this specification. The drawings illustrate an embodiment and, together with the specification, serve to describe the principles of the disclosure.

FIG. 1 is a schematic plan view illustrating a framework structure of a vehicle body rear part;

FIG. 2 is a perspective view of a rear floor panel;

FIG. 3 is an exploded perspective view of the rear floor panel;

FIG. 4 is an enlarged plan view of a portion IV in FIG. 2;

FIG. 5 is a cross-sectional view taken along line V-V in FIG. 4;

FIG. 6 is a cross-sectional view taken along line VI-VI in FIG. 4; and

FIG. 7 is a schematic view illustrating a vehicle body support structure realized by a rear suspension device.

### DETAILED DESCRIPTION

In the technique disclosed in Japanese Patent No. 6962975, by forming beads between adjacent spot welds, when a load at the time of a side impact is input to the center pillar, the side impact load is transmitted to the beads via a lower side end portion of the center pillar stiffener. Transmission of the side impact load to the spot welds is alleviated by the beads. As a result, peeling of the spot welds is suppressed.

However, in the technique disclosed in Japanese Patent No. 6962975, what is done is merely forming beads between weld points of spot welding set at predetermined intervals in the longitudinal direction of the vehicle body. Therefore, when a load is applied in a direction orthogonal to the direction in which the weld points of spot welding and the beads are alternately arranged, that is, in Japanese Patent No. 6962975, when subjected to a load in a direction of pushing up the vehicle body from below, the load is transmitted to both the beads and the weld points of spot welding. As a result, the load is also transmitted to the weld points of spot welding. Therefore, there is a limit in efficiently suppressing peeling of spot welds.

It is desirable to provide a vehicle body framework structure capable of attenuating a stress that acts on a weld point of a panel joined to a frame by spot welding and that causes a spot weld to peel off.

An embodiment of the disclosure will be described below with reference to the drawings. Note that the drawings are schematic. Specific dimensions, shapes, materials, numerical values, the relationship between the thickness and the width of each member, the ratio of the thickness of each member, and the like are merely examples, and are different from actual ones. The drawings include portions having different dimensional relationships, ratios, and shapes.

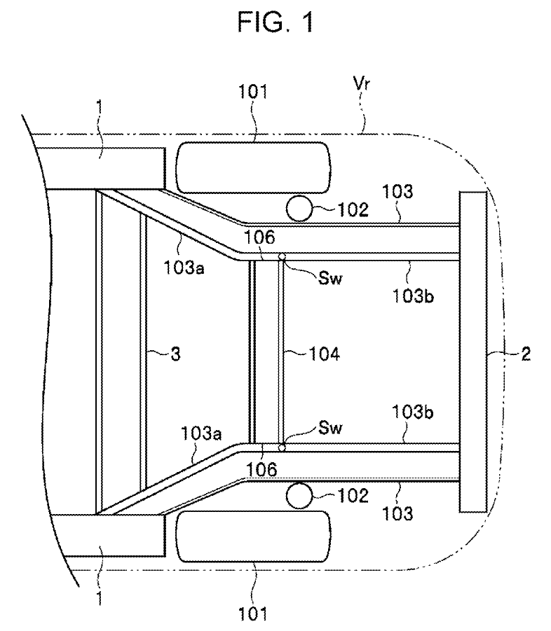

FIG. 1 illustrates a framework structure in the vicinity of a vehicle body rear part Vr. In FIG. 1, reference sign 1 denotes side sills. The side sills 1 are hollow members having a closed cross section. The side sills 1 are provided so as to face each other on the left and right sides in the vehicle width direction of the vehicle body, and extend in the longitudinal direction of the vehicle body. Front ends of rear side frames 103, serving as a pair of opposed first frames, are joined to the opposed surfaces of the rear portions of the side sills 1.

The rear side frames 103 each have a front portion 103a and a rear portion 103b continuous with the rear end of the front portion 103a. The front portions 103a extend from the front ends toward the rear ends. Moreover, the front portions 103a extend inward in the vehicle width direction from the front ends toward the rear ends. The rear portions 103b extend horizontally rearward from the rear ends of the front portions 103a. The rear ends of the rear portions 103b of the pair of opposed rear side frames 103 are coupled to each other via a rear bumper beam 2. The rear bumper beam 2 is disposed horizontally in the vehicle width direction.

A center cross member 3 is disposed between the opposed surfaces of the coupling portions between the rear ends of the side sills 1 and the front ends of the rear side frames 103. The ends of the center cross member 3 are coupled to portions close to the coupling portions. Furthermore, a rear cross member 104, serving as a second frame, is disposed between the opposed surfaces of the rear portions 103b of the rear side frames 103. The ends of the rear cross member 104 are joined to the front ends of the rear portions 103b of the rear side frames 103. The cross members 3 and 104, the rear side frames 103, and the rear bumper beam 2 form a framework of the vehicle body rear part Vr.

Tires 101 for the rear wheels are disposed on the outer sides, in the vehicle width direction, of the front portions 103a of the rear side frames 103. The wheels (not illustrated) on which the tires 101 are mounted are supported by wheel hubs (not illustrated). The wheel hubs are rotatably supported by rear suspension devices 102, serving as biasing members. The rear suspension devices 102 are fixed at positions close to joint line portions 106 between the rear side frames 103 and the rear cross member 104, on the outer sides, in the vehicle width direction, of the rear portions 103b of the rear side frames 103. The cross members 3 and 104 are rigid bodies that reinforce the rear side frames 103.

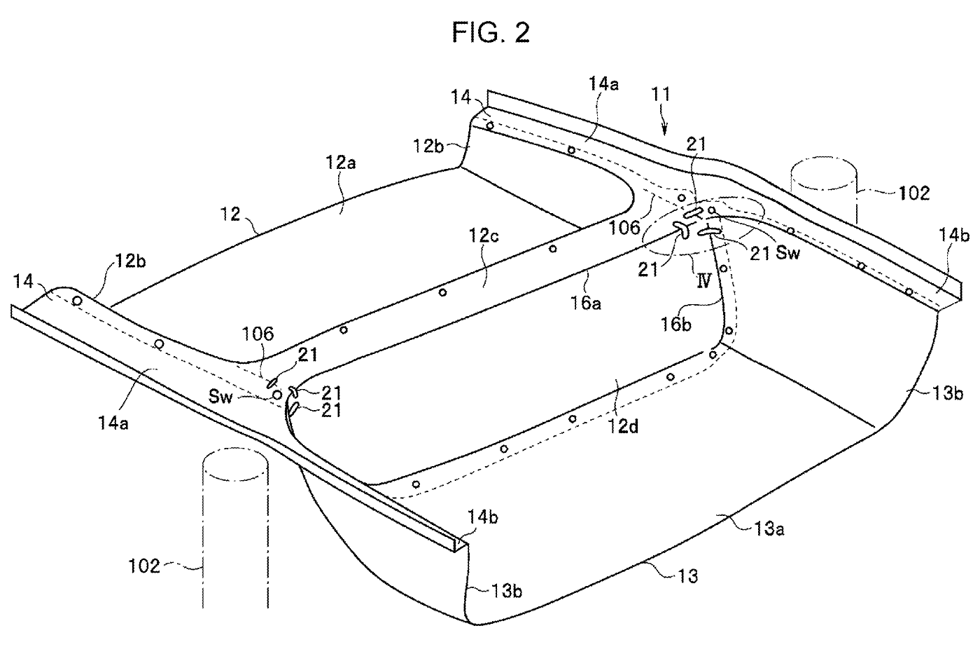

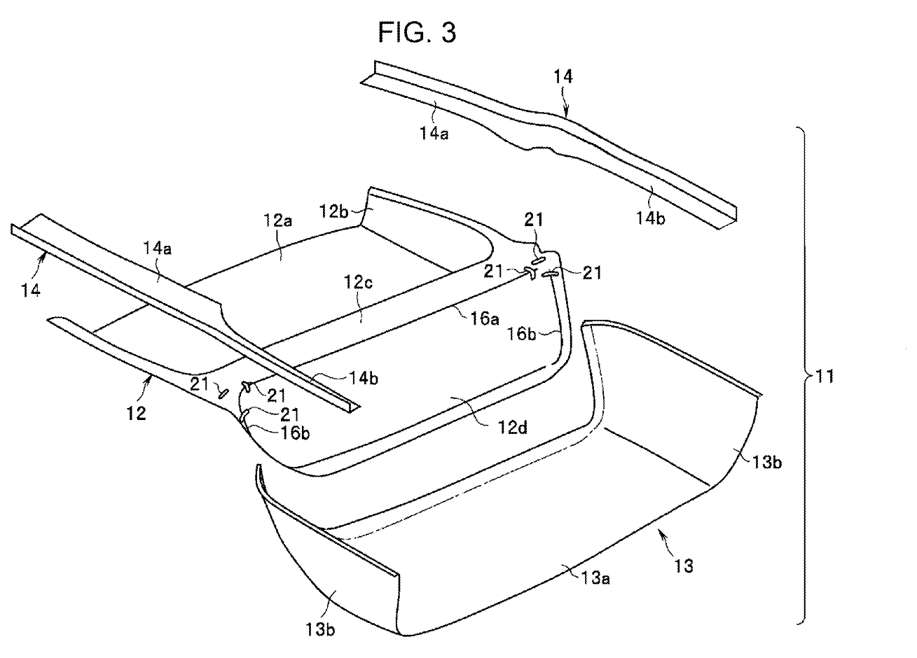

A rear floor panel 11 illustrated in FIG. 2 is joined to upper surfaces of the cross members 3 and 104 and the rear side frames 103, which form the framework of the vehicle body rear part Vr. As illustrated in FIG. 3, the rear floor panel 11 is integrally formed by coupling a rear seat floor panel 12, a luggage compartment floor panel 13, and a pair of opposed rear side panels 14, serving as panel members. The panels 12 to 14 are made of thin steel plates.

The rear seat floor panel 12 is joined to the upper surfaces of the front and rear cross members 3 and 104 and the front portions 103a of the left and right rear side frames 103. The luggage compartment floor panel 13 is joined to the rear cross member 104 and the rear portions 103b of the left and right rear side frames 103. The pair of rear side panels 14 are joined to the left and right rear side frames 103.

The rear seat floor panel 12 has a seat mounting portion 12a. A rear seat (not illustrated) is attached to the seat mounting portion 12a. Vertical wall surfaces 12b are provided on three sides, i.e., the left, right, and rear sides, of the seat mounting portion 12a. The front end of the seat mounting portion 12a is joined to the center cross member 3. Furthermore, flanges are provided at the upper ends of the left and right vertical wall surfaces 12b of the rear seat floor panel 12 so as to be bent outward in the vehicle width direction. The flanges are joined to front portions 14a of the left and right rear side panels 14.

A rear floor portion 12c is provided by bending an upper end of the vertical wall surface 12b provided on the rear portion side of the rear seat floor panel 12. The rear floor portion 12c is joined to the upper surface of the rear cross member 104. Furthermore, in the rear seat floor panel 12, a skirt portion 12d is formed by bending the rear end of the rear floor portion 12c downward. The skirt portion 12d is joined to the front portion of the luggage compartment floor panel 13.

The luggage compartment floor panel 13 has a luggage compartment floor 13a, and vertical wall surfaces 13b are formed by bending on the right and left sides of the luggage compartment floor 13a in the vehicle width direction. The luggage compartment floor 13a is embedded in the region surrounded by the rear cross member 104, the rear bumper beam 2, and the rear portions 103b of the rear side frames 103 provided on the left and right sides, which are illustrated in FIG. 1. Furthermore, flanges are provided at the upper ends of the vertical wall surfaces 13b so as to be bent outward in the vehicle width direction.

The flanges are joined to the rear portions 14b of the rear side panels 14. A single rear floor panel 11 is formed by joining the panels 12 to 14 together by spot-welding the welding margins of the panels 12 to 14 that are superposed on each other. The rear floor panel 11 is joined to the cross members 3 and 104 and the rear side frames 103 by spot welding. Circles in FIG. 2 indicate spot-welded portions.

In the rear floor panel 11, a portion from the rear floor portion 12c to the rear portions 14b of the rear side panel 14 is formed horizontally. A floor board (not illustrated) is mounted on the horizontal surface to close the upper surface of the luggage compartment floor 13a. A spare tire, tools, and the like are stored in the luggage compartment floor 13a. Furthermore, a space defined by the seat back of the rear seat, the floor board, and the vehicle body serves as a luggage room.

As illustrated in FIGS. 1 and 2, in the vicinity of the rear side frames 103 to which the rear suspension devices 102 are fixed, spot-welded portions Sw are set in the vicinity of the joint line portions 106 at which the rear cross member 104 is joined. The spot-welded portions Sw are weld points of spot welding at which the rear floor panel 11 is joined.

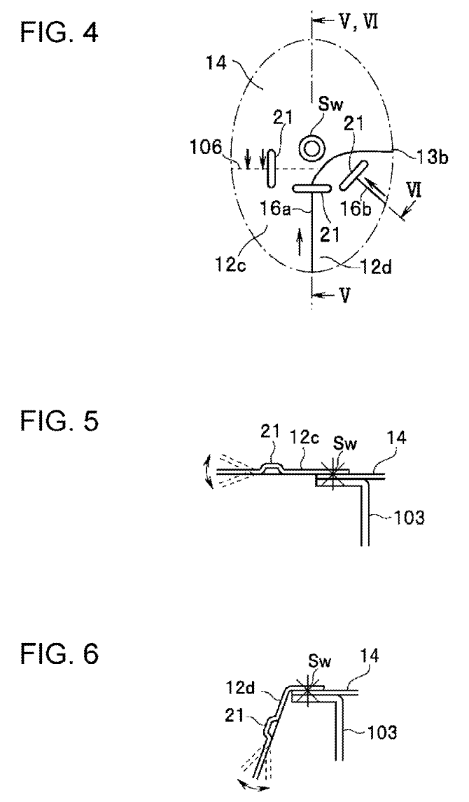

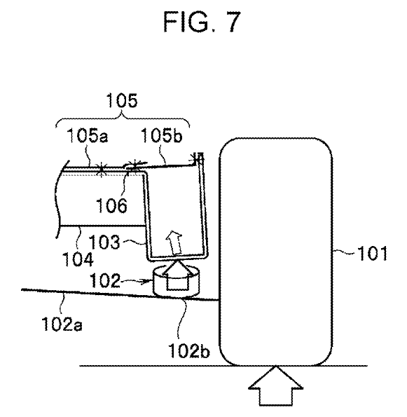

Furthermore, as illustrated in FIG. 4, ridge portions 16a and 16b and the joint line portion 106 extend toward the spot-welded portion Sw. The ridge portion 16a is provided at the boundary between rear floor portion 12c and skirt portion 12d. The ridge portions 16b are provided on the left and right sides of the skirt portion 12d in the vehicle width direction. The joint line portions 106 are portions at which the rear side frames 103 and the rear cross member 104 are joined.

Bead portions 21 are provided on the ridge portions 16a and 16b, at positions close to spot-welded portions Sw. The bead portions 21 are also provided on the rear floor panel 11, at positions above the joint line portions 106 and close to the spot-welded portions Sw. The bead portions 21 are formed substantially orthogonal to the ridge portions 16a and 16b and the joint line portion 106.

Next, the effect of the thus-configured embodiment will be described.

In a state in which the vehicle is traveling, a load (vibration) from the tires 101 on the rear wheel side is transmitted to the rear side frames 103 via the rear suspension devices 102. The rear side frames 103 and the rear cross member 104 are rigid bodies. Therefore, the rear side frames 103 and the rear cross member 104 are not deformed even when receiving the load from the rear suspension devices 102. Hence, when the load is applied from the rear suspension devices 102, the lower portions of the rear side frames 103 tend to be displaced outward in the vehicle width direction.

The joint line portions 106 between the rear side frames 103 and the rear cross member 104 are relatively fragile. Hence, a part of the load applied to the rear side frames 103 is applied to the joint line portions 106, as indicated by arrows in FIG. 4. Another part of the load from the rear side frames 103 is transmitted through the ridge portions 16a and 16b, which have relatively high rigidity, on the rear floor panel 11 and is likely to be concentrated on the spot-welded portions Sw in the vicinity of the joint line portions 106, as indicated by arrows in FIG. 4.

In the present embodiment, the bead portions 21 are provided on the rear floor panel 11, coupled above the joint line portions 106, and on the ridge portions 16a and 16b, at positions close to the spot-welded portions Sw. The bead portions 21 are formed substantially orthogonal to the joint line portions 106 and the ridge portions 16a and 16b.

The rigidity of the joint line portions 106 is increased by the bead portions 21 provided on the rear floor panel 11, which is joined to the upper surface of the joint line portions 106. As illustrated by broken lines in FIGS. 5 and 6, the load transmitted through each of the ridge portions 16a and 16b is dispersed by being received by a surface of the bead portion 21 provided in the middle of the ridge portion. As a result, the load transmitted to the spot-welded portion Sw is attenuated. Thus, the stress concentrated on the spot-welded portion Sw is attenuated, and peeling of the spot-welded portion Sw is suppressed.

As described above, in the present embodiment, the bead portions 21 are formed orthogonal to the joint line portions 106, on the rear floor panel 11 above the joint line portions 106 extending toward the spot-welded portions Sw. Thus, the rigidity of the relatively fragile joint line portions 106 can be increased. Furthermore, the bead portions 21 are formed orthogonal to the ridge portions 16a and 16b extending toward the spot-welded portions Sw. Thus, the load transmitted to the spot-welded portions Sw through the ridge portions 16a and 16b is dispersed by the bead portions 21. As a result, the stress acting on the spot-welded portions Sw so as to peel off the spot-welded portions Sw is attenuated, and the durability of the spot-welded portions Sw is improved.

In the present embodiment, by adding the bead portions 21, peeling of the spot-welded portions Sw is suppressed, and durability is improved. Therefore, it is not necessary to increase the plate thickness of the rear floor panel 11 or to add spot-welded portions, and it is possible to realize a reduction in cost and weight. In addition, because the bead portions 21 are provided above the joint line portion 106 and on the ridge portions 16a and 16b, application to a narrow space is possible, and high versatility can be obtained.

Note that the disclosure is not limited to the above-described embodiment. For example, even in a case where three or more ridge portions extend toward a spot-welded portion Sw, the bead portion 21 is provided for each of the ridge portions.

According to the disclosure, because bead portions are formed orthogonal to ridge portions extending toward spot-welded portions in a panel joined to first and second frames by spot welding, the stress acting on the spot-welded portions to peel off the spot welds can be attenuated by the bead portions.

1. A vehicle body framework structure comprising:
a first frame provided on a vehicle body and extending in a longitudinal direction of the vehicle body;
a second frame coupled to the first frame and configured to suppress displacement of the first frame in a vehicle width direction;
a biasing member fixed to the first frame and disposed at a position close to a joint line portion at which the first frame and the second frame are coupled to each other; and
a panel coupled to the first frame and the second frame,
the panel being coupled to the first frame and the second frame by spot welding at a position adjacent to the joint line portion,
the panel being provided with a ridge portion extending toward the position where spot welding is performed, wherein
a bead portion extending orthogonal to the ridge portion is provided on the ridge portion, at a portion adjacent to the position where the spot welding is performed.

2. The vehicle body framework structure according to claim 1, wherein a bead portion extending orthogonal to the joint line portion is provided on the panel, at a portion above the joint line portion and adjacent to the position where the spot welding is performed.

3. The vehicle body framework structure according to claim 1, wherein the panel is formed by overlapping a plurality of panel members and joining the panel members by spot welding.

4. The vehicle body framework structure according to claim 1, wherein the first frame includes rear side frames respectively disposed on left and right sides of the vehicle body in the vehicle width direction.

5. The vehicle body framework structure according to claim 4, wherein the second frame is a rear cross member that couples the rear side frames.
